(19) United States
(12) Patent Application Publication
(10) Pub. No.: US 2022/0146361 A1
(43) Pub. Date: May 12, 2022

(54) WATER LEAKAGE DETECTION DEVICE FOR WATER AND SEWAGE PIPE

(71) Applicant: USOL CO., LTD., Daejeon (KR)

(72) Inventor: Kwang Suhk OH, Sejong-si (KR)

(21) Appl. No.: 17/479,138

(22) Filed: Sep. 20, 2021

(30) Foreign Application Priority Data
Nov. 6, 2020 (KR) 10-2020-0147678

(51) Int. Cl. G01M 3/24; G01K 13/02

(52) U.S. Cl. CPC G01M 3/243; G01K 13/026

(57) ABSTRACT

A water leakage detection device for a water and sewage pipe is provided. The water leakage detection device includes a sound detector installation pipe having a tubular shape with the same cross-section as that of a hole formed in the water and sewage pipe at an interval and configured to allow one end thereof to be fixed and installed in the hole, and an adjustment valve installed on the inside spaced apart from an end part of the other end of the sound detector installation pipe at a predetermined interval and configured to adjust whether to introduce water inside the water and sewage pipe to the sound detector installation pipe.

### CROSS REFERENCE TO RELATED APPLICATION

The present application claims priority to Korean Patent Application No. 10-2020-0147678 filed on Nov. 6, 2020, which application is incorporated herein by reference in its entirety.

### BACKGROUND

### 1. Field of the Invention

The present disclosure relates to a water leakage detection device for a water and sewage pipe and, more specifically, to a water leakage detection device for a water and sewage pipe to efficiently detect water leakage of water and sewage pipe by sound of water.

### 2. Description of the Related Art

In general, tap water is supplied after water purification at a water purification plant. A water pipeline for supplying water from the water purification plant to a water meter of a consumer is configured to allow water to pass therethrough to stably supply tap water and a sewage pipeline for discharging the water used by the consumer is configured to allow sewage to pass therethrough.

Since water is an indispensable element in human life, the water pipeline and the sewage pipeline are essential infrastructures of living facilities including cities. Such a water and sewage pipe transfers tap water through a pipe connected from the water purification plant and mainly have the form of being buried underground.

For this reason, there is a problem in that it is not possible to accurately determine the state of the water and sewage pipe when it is damaged or aged. When the water and sewage pipe are damaged, water leakage is generated to bring economical loss. When the aged pipe is not replaced, rust may occur and contaminants may penetrate through a damaged portion, and thus problems are generated in water quality management.

To solve water quality management problems, a subject that manages a water and sewage pipe uses a method of sequentially replacing the aged pipes in accordance with an installation date of the water and sewage pipe. However, damage to the water and sewage pipe is not necessarily proportional to aging conditions. The condition of water and sewage pipe also differs significantly depending on the condition of the land in which the pipes are buried. Therefore, the method of sequentially replacing the aged pipes does not select and replace only the damaged water and sewage pipe but rather all the pipes, thereby being a very undesirable method in terms of economic efficiency and efficiency.

Accordingly, methods for finding the location where damage has occurred directly in the water and sewage pipe and replacing only the damaged pipe have been proposed. For example, there is a method of attaching a sound sensor to the outer circumferential surface of the water and sewage pipe to detect a sound generated by the flow of water.

The method was inspired by the fact that the sound of water changes when water leakage occurs and has the advantage of easy installation, but the sound sensor is installed on the outer circumferential surface of the water and sewage pipe, and thus sound detection is greatly affected depending on the thickness and material of the pipe. Accordingly, the method has a problem in that it is difficult to accurately measure the sound.

### Documents of Related Art

(Patent Document 1) Korean Patent No. 10-1876730 (published on Jul. 4, 2018)

### SUMMARY

To solve the described problems, an objective of the present disclosure is to provide a water leakage detection device for a water and sewage pipe, in which a separate pipe for sound detection is installed in the water and sewage pipe, so that water leakage may be efficiently detected without being affected by factors generated due to the water and sewage pipe.

The objective to be achieved of the present disclosure is not limited to those mentioned above, and other objectives not mentioned will be clearly understood by those skilled in the art from the following description.

As a means for solving the described technical objective, a water leakage detection device for a water and sewage pipe according to an embodiment of the present disclosure includes: a sound detector installation pipe having a tubular shape with the same cross-section as that of a hole formed in the water and sewage pipe at an interval and configured to allow one end thereof to be fixed and installed in the hole; and an adjustment valve installed on the inside spaced apart from an end part of the other end of the sound detector installation pipe at a predetermined interval and configured to adjust whether to introduce water inside the water and sewage pipe to the sound detector installation pipe.

The water leakage detection device for a water and sewage pipe may further include a sound detector installed by being connected to the end part of the other end of the sound detector installation pipe and configured to detect a sound of water flowing inside the water and sewage pipe.

The sound detector may be installed in the sound detector installation pipe when an adjustment valve is closed, and the adjustment valve may be left open after installation of the sound detector.

The sound detector may include: an underwater sound sensor configured to detect sound of water in the water and sewage pipe; a temperature sensor configured to measure the temperature of water; and a controller configured to control the underwater sound sensor and the temperature sensor to operate during a predetermined operation time and recording the sound of water detected by the underwater sound sensor.

The controller may record the sound of water upon a predetermined recording time when a water leakage sound is detected by the underwater sound sensor.

The present disclosure provides a water leakage detection device for a water and sewage pipe, in which a sound detector is installed through a separate pipe from the water and sewage pipe, so that the sound detector for water leakage detection may be installed in existing installed water and sewage pipe as well as new water and sewage pipe without an error due to water.

Moreover, the water flowing inside the water and sewage pipe is detected, so that a water leakage sound is detected, thereby providing an effect of installing the sound detector without being affected by factors such as the material and thickness of the water and sewage pipe.

Effects of the present disclosure are not limited to those mentioned above, and other effects not mentioned will be clearly understood by those skilled in the art from the following description.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a perspective view of a water leakage detection device for a water and sewage pipe according to a preferred embodiment of the present disclosure; and

FIG. 2 is a view illustrating an example of installation of the water leakage detection device for a water and sewage pipe according to a preferred embodiment of the present disclosure.

### DETAILED DESCRIPTION

The above objects, other objects, features, and advantages of the present disclosure will be easily understood through the following preferred embodiments in conjunction with the accompanying drawings. However, the present disclosure is not limited to the embodiments described herein and may be embodied in other forms. Rather, the embodiments introduced herein are provided so that the disclosed content may be thorough and complete, and that the spirit of the present disclosure may be sufficiently conveyed to those skilled in the art.

In this specification, when a component is referred to as being on another component, it may be directly formed on the other component or a third component may be interposed therebetween. In addition, in the drawings, the thickness of the components is exaggerated for the effective description of the technical content.

When it is stated that any element, component, device, or system includes a component consisting of a program or software, even if not explicitly stated, it should be understood that the element, component, device, or system includes hardware (e.g., memory, CPU, etc.) or other programs or software (e.g., drivers necessary to run an operating system or hardware) necessary for execution or operation.

In addition, it should be understood that an element (or component) may be implemented in software, hardware, or in any form of software and hardware, unless otherwise specified in implementation of the element (or component).

In addition, the terminology used herein is for the purpose of describing the embodiments and is not intended to limit the present disclosure. In this specification, the singular also includes the plural unless specifically stated otherwise in the phrase. As used herein, the terms ‘comprises’ and/or ‘comprising’ do not exclude the presence or addition of one or more other components.

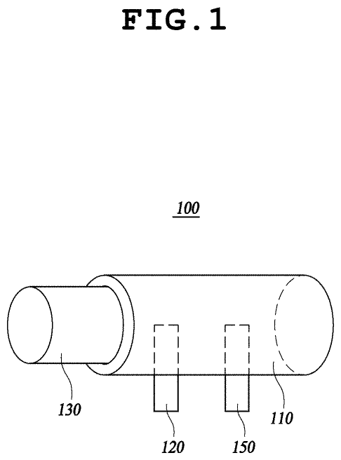

FIG. 1 is a perspective view of a water leakage detection device for a water and sewage pipe according to a preferred embodiment of the present disclosure.

Referring to FIG. 1, the water leakage detection device 100 for a water and sewage pipe according to a preferred embodiment of the present disclosure is a dedicated device for installing a sound detector 130 in the water and sewage pipe.

To detect water leakage occurring in the water and sewage pipe to prevent an accident, existing methods that the sound detector 130 is installed in the water and sewage pipe to detect the water leakage have been present.

However, the methods install the sound detector 130 on the outside of the water and sewage pipe or directly install the sound detector 130 in a hole after forming the hole in the water and sewage pipe, so that it is difficult to install the sound detector 130 in the water and sewage pipe while water flows and a problem may be also generated in the accuracy of the sound detector 130.

Accordingly, in the present embodiment, the sound detector 130 is installed in the water and sewage pipe through a water leakage detection device 100, which is a dedicated device for installing the sound detector 130, so that influence of the water existing in the water and sewage pipe is prevented.

The water leakage detection device 100 includes a sound detector installation pipe 110, an adjustment valve 120, and a sound detector 130.

The sound detector installation pipe 110 is formed in a tubular shape having the same cross-section as that of a hole formed in the water and sewage pipe and is installed by fixing one end thereof in the hole formed in the water and sewage pipe. The sound detector installation pipe 110 should be formed in a size allowing the sound detector installation pipe 110 to be inserted into the hole formed in the water and sewage pipe in consideration of the thickness thereof.

The adjustment valve 120 is installed on the inside spaced apart from an end part of the other end of the sound detector installation pipe 110 at a predetermined interval and is used for adjusting whether to introduce water inside the water and sewage pipe to the sound detector installation pipe 110. Here, installing the adjustment valve 120 on the inside spaced apart from the end part of the other end of the sound detector installation pipe 110 is to secure space for allowing the sound detector 130 to be inserted thereinto.

When installing the water leakage detection device 100 is installed in the water and sewage pipe, to prevent the sound detector 130 from coming in contact with the water, the sound detector installation pipe 110 is installed in the water and sewage pipe when the adjustment valve 120 installed in the sound detector installation pipe 110 is closed. After both the sound detector installation pipe 110 and the sound detector 130 are completely installed, the adjustment valve 120 should be opened.

At this time, according to a preferred embodiment of the present disclosure, the water leakage detection device 100 includes an opening/closing valve 150 opening/closing the sound detection installation pipe 110 to prevent the water from flowing out when the sound detector 130 is placed in the water flowing into the sound detector installation pipe 110 after the sound detector 130 is installed in the sound detector installation pipe 110.

The sound detector 130 detects a sound of the water flowing inside the water and sewage pipe to monitor water leakage and may record the sound of water when a water leakage sound is detected while monitoring the sound of water. Since a sound level generated when the water normally flows significantly differs from a sound level when the water leakage occurs, the sound level when the water leakage occurs is stored and used for detecting the water leakage sound.

Although not shown, the sound detector 130 includes an underwater sound sensor, a temperature sensor, and a controller. The sound detector 130 utilizes the water flowing inside the water and sewage pipe as a medium to detect a sound and has an advantage of securing a constant detection performance regardless of the type of the water and sewage pipe.

The underwater sound sensor detects the sound of the water flowing inside the water and sewage pipe. As the underwater sound sensor, various sound sensors, such as a microphone, capable of detecting a sound can be applied, but a type capable of being used in the water should be applied necessarily.

The temperature sensor measures the temperature of the water flowing inside the water and sewage pipe, so that the temperature sensor should be installed adjacent to the underwater sound sensor. The temperature sensor is applied to the sound detector 130 because the transfer speed of the sound is changed in accordance with the temperature of water.

More specifically, the sound transfer speed of water is 1,433 m/sec in the water of 15° C. and is 1,483 m/sec in the water of 20° C. and shows the form that the sound transfer speed is increased by 4.6 m/sec whenever the temperature is increased by 1° C. Therefore, the speed when the water leakage sound is transferred should be known to find out a correct water leakage point and the temperature of water at the point of time when the water leakage sound occurs should be known to check the correct speed when the water leakage sound is transferred. As such, as the speed when the water leakage sound is transferred is changed depending on the temperature of water, the speed when the water leakage sound is transferred to the sound detector 130 may checked in consideration of the water temperature included in water leakage information.

The controller controls the function of the underwater sound sensor and the temperature sensor and may control the sound detector 130 to operate during a predetermined operation time. Moreover, the controller records the sound of water upon a predetermined recording time when the water leakage sound is detected by the underwater sound sensor.

In general, since the amount of the water flowing inside the water and sewage pipe is great, the morning and evening hours and the like when water consumption is high, are not suitable for detecting the water leakage sound. To detect a correct water leakage sound, it is preferred that the water leakage sound is detected in, as an example, early morning hours when the use amount of water is less. Accordingly, it is preferred that the controller controls the sound detector 130 to operate in only the predetermined operation time, such as early morning hours, when the use amount of water is less.

In addition, the sound detector 130 may be configured to communicate with an external server (not shown). In this case, the sound detector 130 may further include a communication module (not shown) for communications with the server.

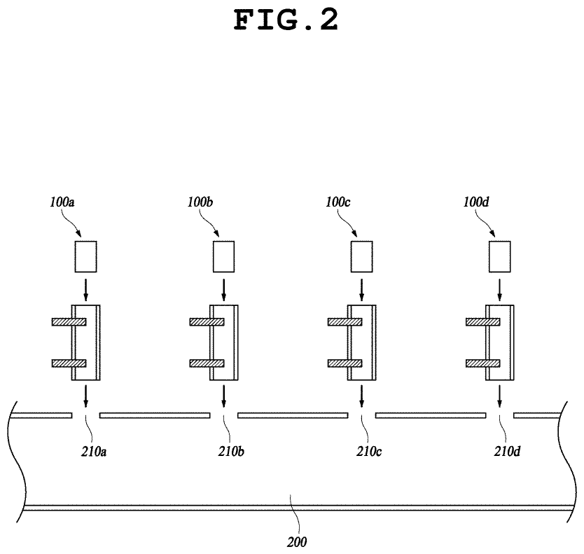

FIG. 2 is a view illustrating an example of installation of the water leakage detection device for a water and sewage pipe according to a preferred embodiment of the present disclosure.

In this embodiment, a procedure for installing the water leakage detection device 100 described in FIG. 1 in the water and sewage pipe 200 will be described. As shown, the water and sewage pipe 200 in the form of a long pipe is installed. Here, the water and sewage pipe 200 may correspond to both the case of being already buried and the case of being newly installed.

Holes 210a, 210b, 210c, and 210d are formed in the upper portion of the water and sewage pipe 200 to be spaced apart from each other. Here, the holes 210a, 210b, 210c, and 210d may be generally circular but may be formed in other shapes as needed. In addition, the holes 210a, 210b, 210c, and 210d should be sized to allow the water leakage detection device 100 to be accurately inserted and fit so that water does not leak through gaps.

Looking at the procedure for installing the device 100 in the water and sewage pipe 200, first, the holes 210a, 210b, 210c, and 210d are formed in the water and sewage pipe 200, and the sound detector installation pipes 110 in which the adjustment valve 120 are installed is installed in the holes 210a, 210b, 210c, and 210d, respectively, while the opening/closing valve 150 is opened and the adjustment valve 120 is closed. Thereafter, after installing the sound detector 130 in the sound detector installation pipe 110, the adjustment valve 120 is opened.

When the installation is completed in this way, the water flowing in the water and sewage pipe 200 flows into the sound detector installation pipe 110 and the water flowing into the sound detector installation pipe 110 also comes into contact with the sound detector 130.

Thereafter, when the water flows into the installation pipe 110 in a state in which the sound detector 130 is submerged in the water, the opening/closing valve 150 is closed to prevent the water from leaking to the outside.

Accordingly, the sound detector 130 detects the sound of water flowing in the water and sewage pipe 200 and performs operations, such as recording the sound of water and measuring the temperature of the water by the temperature sensor, when a leakage sound other than the normal sound of water is detected.

According to the method for installing the device 100 shown in the present embodiment in the water and sewage pipe 200, the device 100 may be installed in the newly installed water and sewage pipe 200, as well as the previously installed water and sewage pipe 200, without difficulty.

More specifically, since water is continuously flowing when the water and sewage pipe 200 is already buried and in use, it may be difficult to install the sound detector 130 and an error may occur in the operation of the sound detector 130 if the water comes into contact before installation is complete.

On the other hand, in the present embodiment, even in the case in which the water and sewage pipe 200 is already buried, since the sound detector 130 may be installed when water does not flow inside the water and sewage pipe 200 by the adjustment valve 120 after the holes 210a, 210b, 210c, and 210d are formed, the installation can be completed in a state in which the water does not come into contact with the sound detector 130.

Those skilled in the art to which the present disclosure pertains will understand that the present disclosure may be embodied in other specific forms without changing the technical spirit or essential characteristics thereof. Therefore, it should be understood that the embodiments described above are illustrative in all respects and not restrictive. The scope of the present disclosure is indicated by the following claims rather than the above detailed description, and all changes or modifications derived from the meaning and scope of the claims and their equivalent concepts should be interpreted as being included in the scope of the present disclosure.

National R&D Project Information

| | |
|---|---|
| Project Identification Number | 202008168 |
| Project Number | 2020003160020 |
| Government Department | Ministry of Environment |
| Project Management Institution | Korea Environmental Industry |
| | and Technology Institute |
| Research project | Green Innovation Company |
| | Growth Support |
| | Program(commercialization) |
| Research Task | Development of an AI-based |
| | smart leak detection system |
| Contribution Rate | 1/1 |
| Task Execution Instituion | USOL Co., Ltd. |
| Research Period | 28 Sep. 2020.~31 Dec. 2022 |

What is claimed is:

1. A water leakage detection device for a water and sewage pipe, the water leakage detection device comprising:
a sound detector installation pipe having a tubular shape with the same cross-section as that of a hole formed in the water and sewage pipe at an interval and configured to allow one end thereof to be fixed and installed in the hole; and
an adjustment valve installed on an inside spaced apart from an end part of the other end of the sound detector installation pipe at a predetermined interval and configured to adjust whether to introduce water inside the water and sewage pipe to the sound detector installation pipe.

2. The water leakage detection device for a water and sewage pipe of claim 1, further comprising a sound detector installed by being connected to the end part of the other end of the sound detector installation pipe and configured to detect a sound of water flowing inside the water and sewage pipe.

3. The water leakage detection device for a water and sewage pipe of claim 2, wherein the sound detector is installed in the sound detector installation pipe when an adjustment valve is closed, and the adjustment valve is left open after installation of the sound detector.

4. The water leakage detection device for a water and sewage pipe of claim 2, wherein the sound detector comprises:
an underwater sound sensor configured to detect sound of water in the water and sewage pipe;
a temperature sensor configured to measure a temperature of water; and
a controller configured to control the underwater sound sensor and the temperature sensor to operate during a predetermined operation time and recording the sound of water detected by the underwater sound sensor.

5. The water leakage detection device for a water and sewage pipe of claim 4, wherein the controller records the sound of water upon a predetermined recording time when a water leakage sound is detected by the underwater sound sensor.
